(19) United States
(12) Patent Application Publication
(10) Pub. No.: US 2009/0138268 A1
(43) Pub. Date: May 28, 2009

(54) DATA PROCESSING DEVICE AND COMPUTER-READABLE STORAGE MEDIUM STORING SET OF PROGRAM INSTRUCTIONS EXCUTABLE ON DATA PROCESSING DEVICE

(75) Inventors: Hirotoshi MAEHIRA, Nagoya-shi (JP); Masahiro FUJISHITA, Nagoya-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: BROTHER KOGYO KABUSHIKI KAISHA, Aichi-ken (JP)

(21) Appl. No.: 12/324,463

(22) Filed: Nov. 26, 2008

(30) Foreign Application Priority Data
Nov. 28, 2007 (JP) 2007-308085

(51) Int. Cl. G10L 13/00; G06F 3/00

(52) U.S. Cl. 704/260; 715/865; 704/E13.001

(57) ABSTRACT

A data processing device includes a displaying unit, a receiving unit, a determining unit, and a controlling unit. The displaying unit displaying one of a first operation screen and a second operation screen. Input data is inputted into the receiving unit by a user. The determining unit determines, based on at least one of the input data and settings of an OS, which of the first operation screen and the second operation screen should be displayed on the displaying unit. The controlling unit controls the displaying unit to display the first operation screen if the determining unit determines that the first operation screen should be displayed on the displaying unit, and control the displaying unit to display the second operation screen if the determining unit determines that the second operation screen should be displayed on the displaying unit.

### CROSS REFERENCE TO RELATED APPLICATION

This application claims priority from Japanese Patent Application No. 2007-308085 filed Nov. 28, 2007. The entire content of this application is incorporated herein by reference.

### TECHNICAL FIELD

The present invention relates to a data processing device and a computer-readable storage medium storing a set of program instructions executable on a data processing device.

### BACKGROUND

Conventional data processing programs called screen readers function to convert text data displayed on a personal computer (hereinafter abbreviated as “PC”) to voice that can be played audibly in order to assist people with visual impairments in using ordinary PCs. One such data processing program designed to support the visually impaired in using a PC is disclosed in Japanese unexamined patent application publication No. 2002-288071. This program provides a display area within an operation screen of a browser that is application for acquiring and displaying World Wide Web (WWW) data. The display area is used to display menus with links or other data, enabling the visually impaired to acquire WWW data through simple operations. When the browser acquires menu data for the visually impaired in addition to the WWW data, the program can display this menu data in the operation screen of the browser, making the browser more user-friendly to the visually impaired user.

### SUMMARY

However, in the technology of Japanese unexamined patent application publication No. 2002-288071, menu items for the visually impaired displayed in the operation screen of the browser are also included with the WWW data displayed in the operation screen of the browser. Accordingly, the user hears the similar data included in the display area and the WWW data repeatedly by the screen reader, making it more difficult to understand what information is displayed in the operation screen of the browser. Alternatively, if the browser were provided with both an operation screen for the visually impaired that is convenient for people with visual impairments and an operation screen for the visually sound, or sighted, that is convenient for sighted people, the user would be required to perform operations to select or toggle the operation screen to the desired screen. This is particularly inconvenient for visually impaired users for which each operation is time-consuming. Above described problem is more remarkable when an application program provided with a plurality of operation screens including an operation screen for the sighted and an operation screen for the visually impaired is being installed on the PC.

In view of the foregoing, it is an object of the present invention to provide a data processing device and a computer-readable storage medium storing a set of program instructions capable of instructing the application program provided with the plurality of operation screens including the operation screen for the sighted and the operation screen for the visually impaired, to display the operation screen best suited to the user based on settings data for the PC when the application program is being installed on the PC.

In order to attain the above and other objects, the present invention provides a data processing device on which an OS is installed and on which a screen reader and an application can be installed. The application provides with an operation screen when installed on the data processing device. The operation screen has a first operation screen for sighted users and a second operation screen for visually impaired users. The second operation screen includes voicing data. The screen reader voicing the voicing data. The data processing device includes a displaying unit, a receiving unit, a determining unit, and a controlling unit. The displaying unit displays one of the first operation screen and the second operation screen in at least one of a text character form and an image form. The screen reader voices the voicing data when the second operation screen is displayed on the displaying unit. Input data is inputted into the receiving unit by a user. The determining unit determines, based on at least one of the input data and settings of the OS, which of the first operation screen and the second operation screen should be displayed on the displaying unit. The controlling unit controls the displaying unit to display the first operation screen if the determining unit determines that the first operation screen should be displayed on the displaying unit, and controls the displaying unit to display the second operation screen if the determining unit determines that the second operation screen should be displayed on the displaying unit.

Another aspect of the present invention provides a computer-readable storage medium storing a set of program instructions executable on a data processing device on which an OS is installed and on which a screen reader and an application can be installed. The application provides with an operation screen when installed on the data processing device. The operation screen has a first operation screen for sighted users and a second operation screen for visually impaired users. The second operation screen includes voicing data. The screen reader voicing the voicing data. The data processing device includes: a displaying unit displaying one of the first operation screen and the second operation screen in at least one of a text character form and an image form, the screen reader voicing the voicing data when the second operation screen is displayed on the displaying unit; and a receiving unit into which input data is inputted by a user. The program includes instructions for: a) determining, based on at least one of the input data and settings of the OS, which of the first operation screen and the second operation screen should be displayed on the displaying unit; and b) controlling the displaying unit to display the first operation screen if in a) it is determined that the first operation screen should be displayed on the displaying unit, and controlling the displaying unit to display the second operation screen if in a) it is determined that the second operation screen should be displayed on the displaying unit.

### BRIEF DESCRIPTION OF THE DRAWINGS

The particular features and advantages of the invention as well as other objects will become apparent from the following description taken in connection with the accompanying drawings, in which:

FIG. 1 is a block diagram showing the electrical structure of a PC according to a first embodiment of the present invention;

FIG. 2(a) is a screenshot showing an example of an installation UI-A(-B) for the visually impaired;

FIG. 2(b) is a screenshot showing an example of an installation UI-C for the visually impaired;

FIG. 3 is a screenshot showing an example of an installation UI for the sighted;

FIG. 4(a) is a screenshot showing an example of a UI for the visually impaired;

FIG. 4(b) is a screenshot showing an example of a UI for the sighted;

FIG. 5 is a flowchart illustrating steps in a main process performed on the PC;

FIG. 6(a) is a screenshot showing an example of a dialog box A;

FIG. 6(b) is a flowchart illustrating steps in a voicing screen displaying process performed on the PC;

FIG. 7(a) is a block diagram showing the electrical structure of a PC according to a second embodiment of the present invention;

FIG. 7(b) is a flowchart illustrating a main process performed on the PC according to the second embodiment;

FIG. 8(a) is a block diagram showing the electrical structure of a PC according to a third embodiment of the present invention; and

FIG. 8 (b) is a flowchart illustrating a main process performed on the PC according to the third embodiment.

### DETAILED DESCRIPTION

Next, preferred embodiments of the present invention will be described while referring to the accompanying drawings.

A computer-readable storage medium storing a set of program instructions executable on a data processing device according to the present invention corresponds to an installation program according to a first embodiment. The installation program is launched when an application program X having an operation screen for the visually impaired suitable for a screen reader (voicing software) and an operation screen for the sighted is being installed on the PC 1. More precisely, the installation program determines whether a screen reader is installed on the PC 1 and sets the operation screen displayed by the application program X based on the determination results.

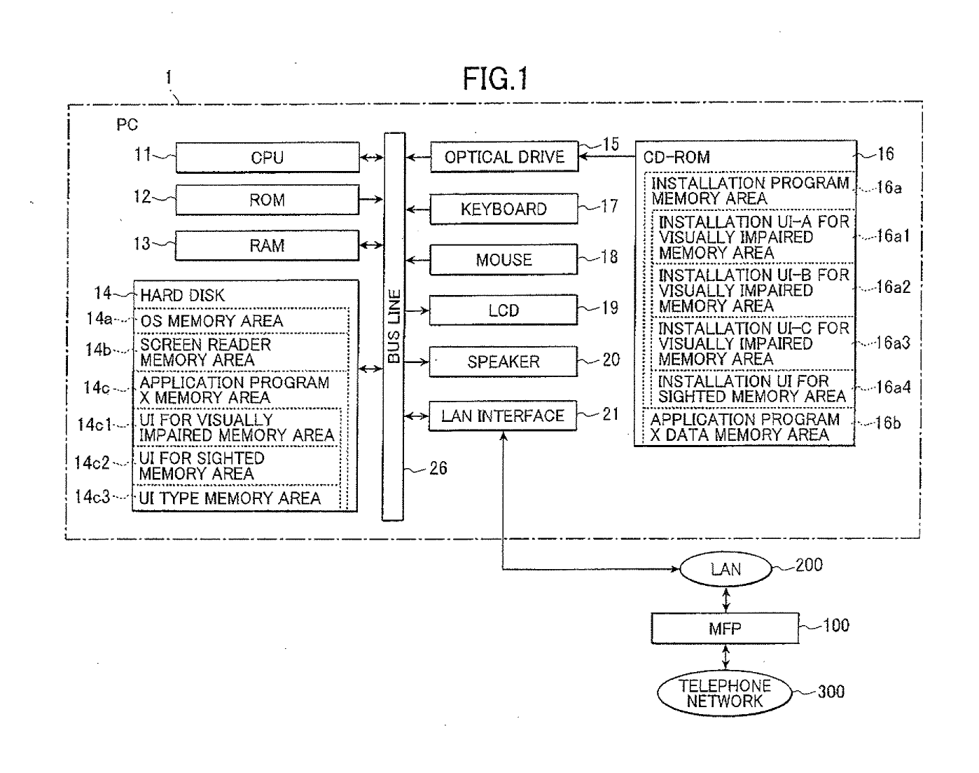

FIG. 1 is a block diagram showing the electrical structure of the PC 1 on which the installation program according to the first embodiment is launched.

For example, when the installation program described above is launched on the PC 1 on which a screen reader has been installed, the installation program installs the application program X on the PC 1, and specifies the operation screen best suited to the user as the operation screen displayed on an LCD 19 of the PC 1. Hence, this installation program is user-friendly to visually impaired users.

The application program X is a program capable of using various functions possessed by a multifunction peripheral (MFP) 100 connected to the PC 1 via a LAN 200, including a facsimile function, printer function, scanner function, and copier function The MFP 100 is also connected to a telephone network 300 required for transmitting data with the facsimile function.

The PC 1 is primarily configured of a CPU 11, a ROM 12, a RAM 13, a hard disk 14, an optical drive 15, a keyboard 17, a mouse 18, the LCD 19, a speaker 20, and a LAN interface 21, all of which components are interconnected via a bus line 26.

The CPU 11 controls the various functions possessed by the PC 1 and each component connected to the bus line 26 based on fixed values and programs stored on the ROM 12, RAM 13, and hard disk 14 or according to signals exchanged via the LAN interface 21.

The ROM 12 is a non-rewritable memory storing control programs and the like executed on the PC 1. The RAM 13 is a rewritable volatile memory used to temporarily store various data when the CPU 11 executes operations on the PC 1.

The hard disk 14 is a rewritable, nonvolatile memory. Hence, data stored on the hard disk 14 is preserved even after the power supply to the PC 1 is turned off. The hard disk 14 is provided with an OS memory area 14a, a screen reader memory area 14b, and an application program X memory area 14c.

The OS memory area 14a stores an operating system (OS). The OS is a base program designed to manage components connected to the bus line 26 and is required when the operator uses the PC 1.

The OS is provided with a plurality of setting options related to input operations, as will be described later. By selecting one of the multiple choices provided for each setting option, the user can customize the PC 1 for a more pleasant experience. For example, the user can set the speed of the mouse cursor displayed on the LCD 19 faster or slower than a prescribed default speed (initially value set in the OS) and can set the size of text data displayed on the LCD 19 larger or smaller than a prescribed default text size (initially value set in the OS).

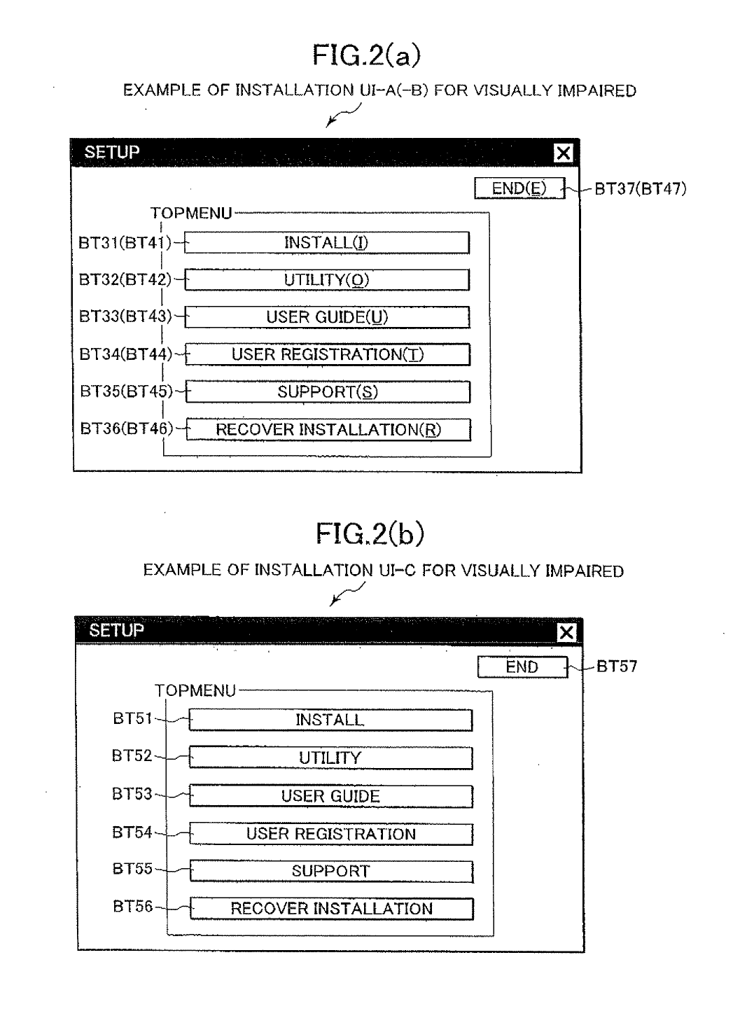

The screen reader memory area 14b stores a screen reader designed to convert text data displayed on the LCD 19 to voice. A screen reader functions to assist a visually impaired user in using the PC 1. When the user performs a key operation or the like to select text data displayed on the LCD 19, the screen reader converts the selected text data to voice signals and outputs the voice signals through the speaker 20. For example, if the user selects one of buttons BT31-BT37 (described later in greater detail with reference to FIG. 2(a)) displayed on the LCD 19, the screen reader converts a button name configured of text data and assigned to the selected button to voice signals and audibly outputs the voice signals, enabling a visually impaired person to operate the PC 1 based on voice.

While there are various types of screen readers, any one of the screen readers can be stored in the screen reader memory area 14b. Each screen reader has selection different rules for determining which data among the text data selected through user operations is to be converted to voice.

Here, selection rules will be described for sample screen readers A, B, and C. For example, if the user selects text data including symbols (such as parentheses and underscore in this example) within a display on the LCD 19, such as “File (F)” through key operations and the like, screen readers A and B exclude text data with the parentheses when voicing the data. In other words, these screen readers only output voice for the word “File” from the speaker 20 in this example. However, screen reader C voices all text data, outputting the phrase “file parenthesis F underscore close parenthesis” from the speaker 20.

A visually impaired user can easily understand the content voiced by screen readers A and B since text data surrounded by parentheses is excluded, but the user may not accurately understand the content when the text data within the parentheses is important. On the other hand, screen reader C that is a general screen reader converts all text data to voice, enabling the user to hear the entire content, but voiced content including numerous symbols and the like may also be difficult for a visually impaired user to understand.

Recently, numerous applications provided with Microsoft Access Accessibility (MSAA) have been developed to assist the visually impaired in using a PC. The application provided with MSAA can associate text data not displayed with text data displayed on the LCD 19, and store the text data not displayed on the LCD 19, for example. Text data not displayed on the LCD 19 is referred to as “embedded data.” Embedded data is primarily configured of single words or brief phrases that the developer of the application deems appropriate and necessary for the screen reader to voice to a visually impaired user.

In the present embodiment, screen reader A possesses a function to voice embedded data. If embedded text data has been associated with text data selected by the user through key operations or the like, screen reader A gives priority to reading the embedded text data. Hence, screen reader A used together with the application provided with MSAA can output single words and brief phrases in embedded data regardless of the text data displayed on the LCD 19, enabling a visually impaired user to accurately understand the text data selected through key operations and the like. The installation program according to the preferred embodiments of the present invention is a program provided with MSAA. In the preferred embodiments, screen readers B and C do not possess a function to voice embedded data.

The application program X memory area 14c stores the application program X, which facilitates use of functions on the MFP 100 connected to the PC 1 via the LAN 200. Since the screen reader runs simultaneously when the visually impaired user uses the application program X, the screen reader can convert text data displayed in an operation screen of the application program X to voice data that is outputted through the speaker 20. Accordingly, a visually impaired user can operate the application program X based on the voice.

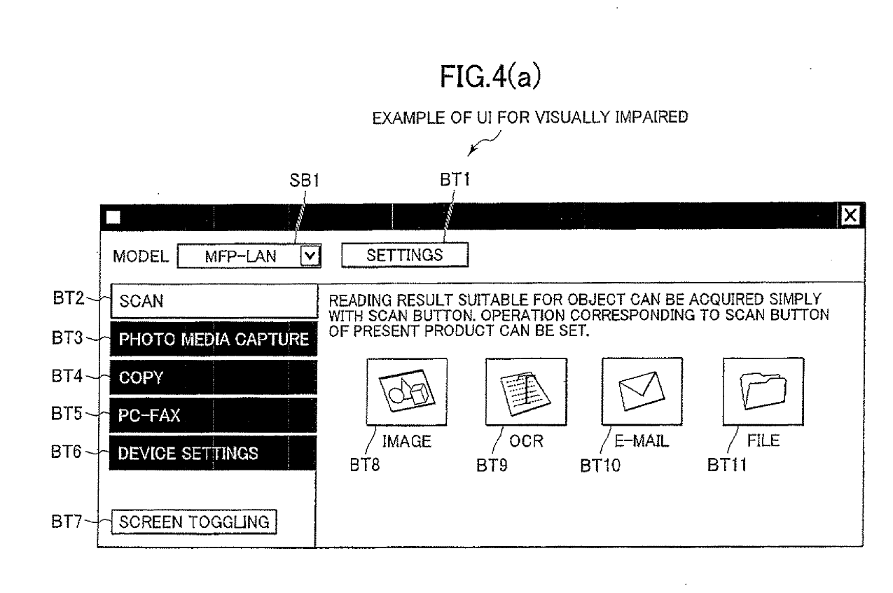

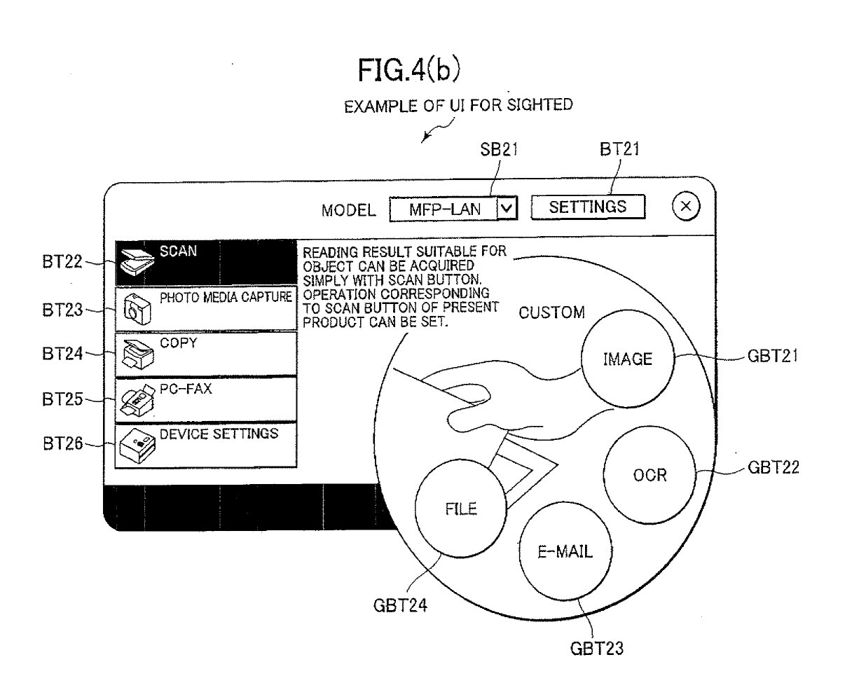

The application program X memory area 14c is provided with a UI for the visually impaired memory area 14c1, a UI for the sighted memory area 14c2, and a UI type memory area 14c3. The UI for the visually impaired memory area 14c1 stores a UI for the visually impaired (described later in greater detail with reference to FIG. 4(a)), which is an operation screen that facilities input operations for a visually impaired user. The UI for the sighted memory area 14c2 stores a UI for the sighted (described later in greater detail with reference to FIG. 4(b)), which is an operation screen that facilitates input operations for a sighted user. The UI for the visually impaired is the operation screen for the visually impaired of the application program X, and the UI for the sighted is the operation screen for the sighted of the application program X.

The UI type memory area 14c3 stores a UI type indicating the operation screen to be displayed on the LCD 19. When the application program X is launched on the PC 1, the UI for the visually impaired is displayed on the LCD 19 if the UI type memory area 14c3 stores a UI type indicating the UI for the visually impaired (“1”, for example), and the UI for the sighted is displayed on the LCD 19 if the UI type memory area 14c3 stores a UI type indicating the UI for the sighted (“2”, for example).

The optical drive 15 functions to read data stored on an optical disc medium, such as a CD or DVD A non-rewritable optical disc medium, such as a CD-ROM 16, is inserted into the optical drive 15. The CD-ROM 16 includes an installation program memory area 16a, and an application program X data memory area 16b.

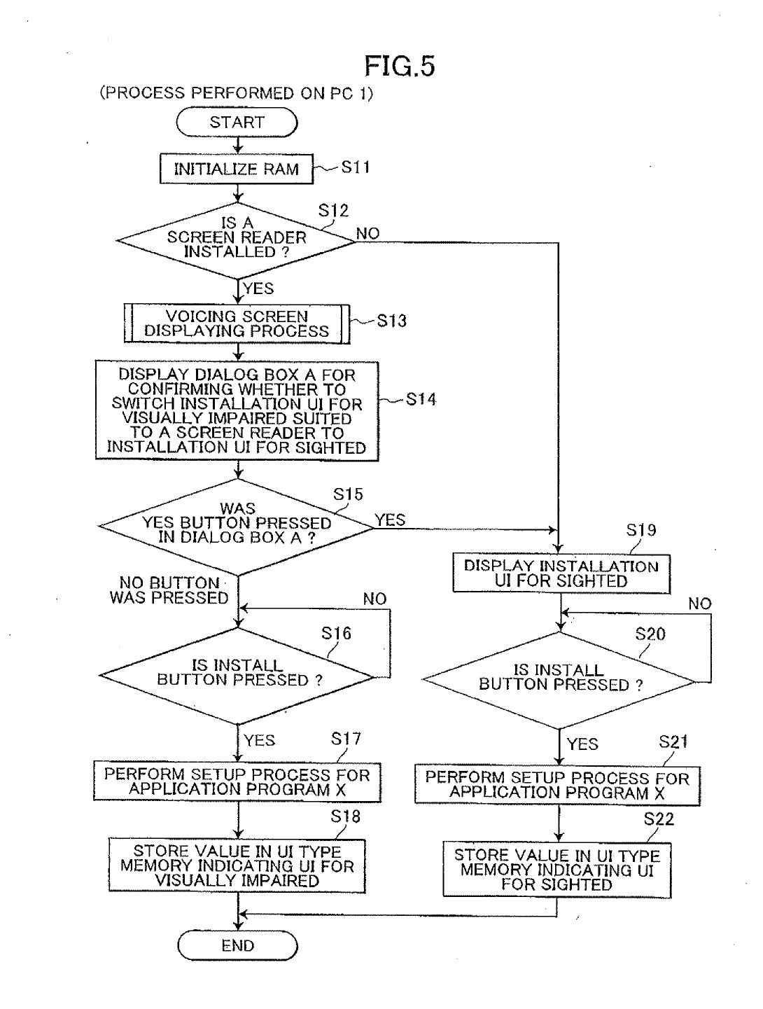

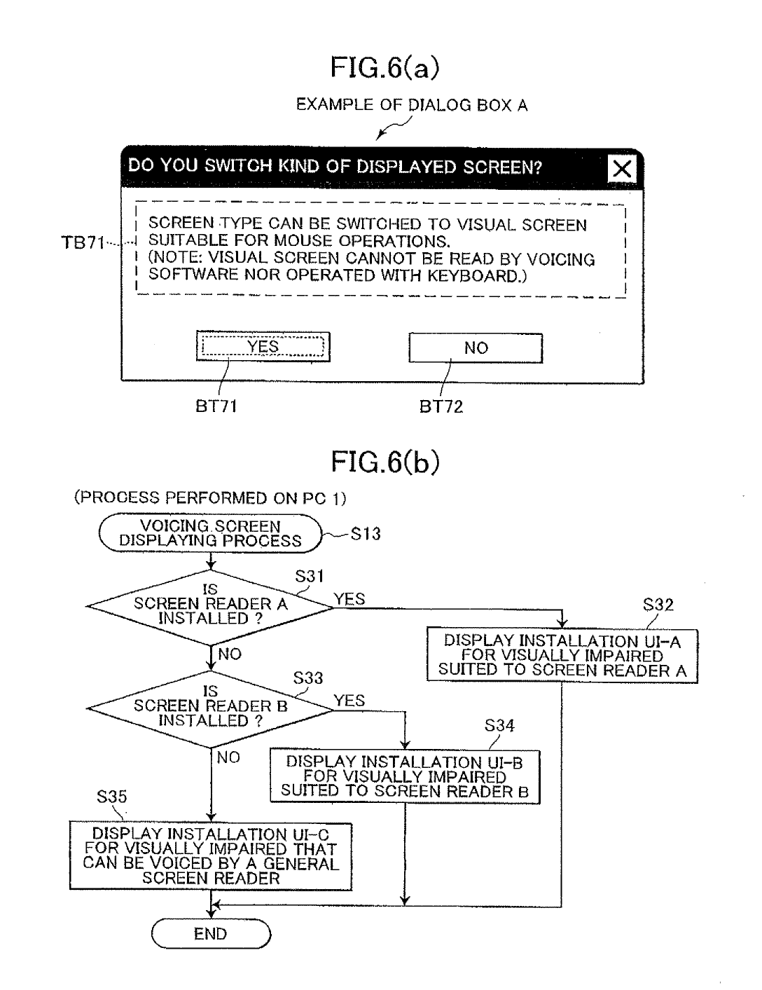

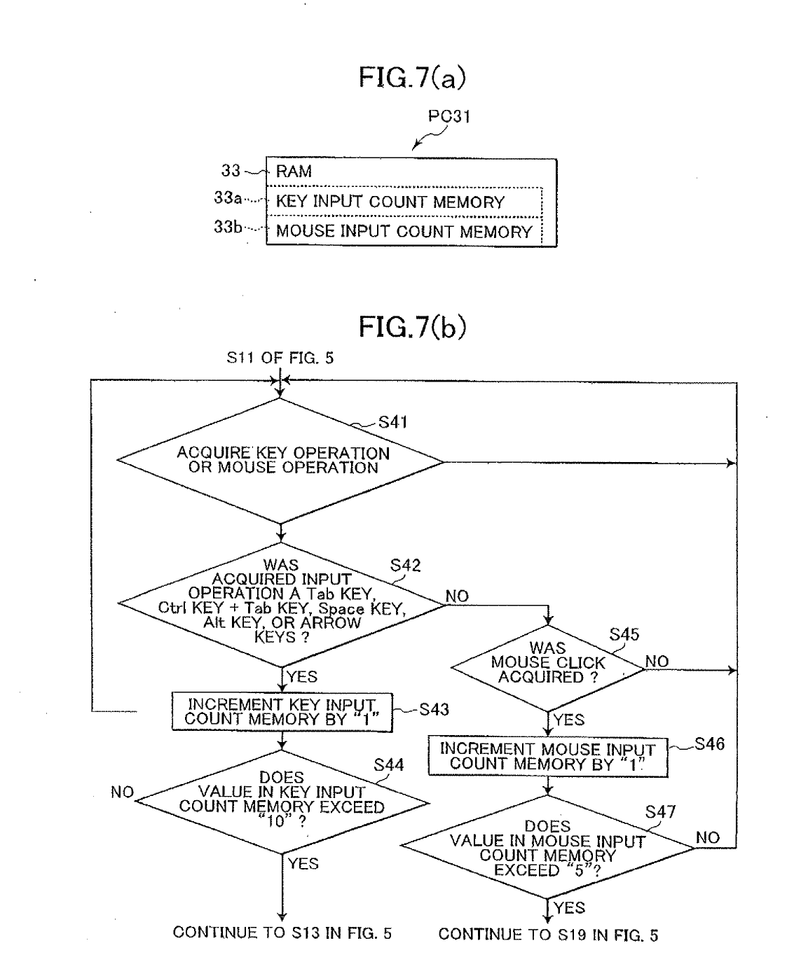

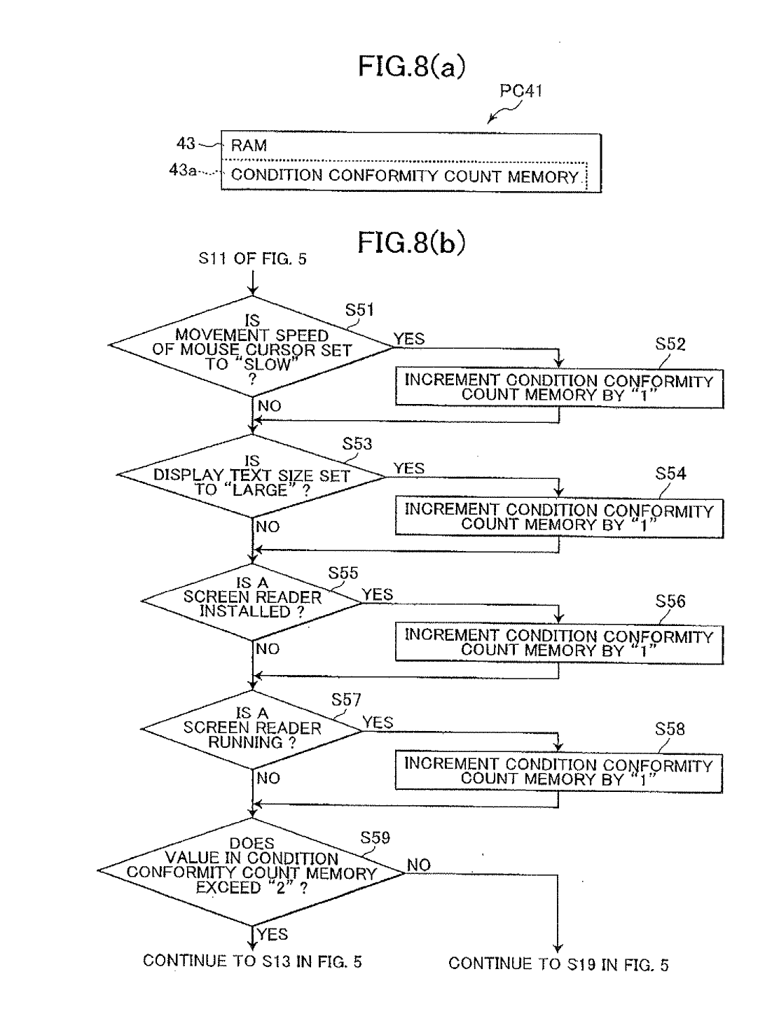

The installation program memory area 16a stores the installation program according to the present embodiment that is launched when the application program X is installed on the PC 1. The installation program memory area 16a also stores various programs for implementing a main process illustrated in the flowchart of FIG. 5, and a voicing screen displaying process illustrated in the flowchart of FIG. 6.

The installation program memory area 16a of the CD-ROM 16 is further provided with an installation UI-A for the visually impaired memory area 16a1, an installation UI-B for the visually impaired memory area 16a2, an installation UI-C for the visually impaired memory area 16a3, and an installation UI for the sighted memory area 16a4.

The installation UI-A for the visually impaired memory area 16a1 stores an installation UI-A for the visually impaired, the installation UI-B for the visually impaired memory area 16a2 stores an installation UI-B for the visually impaired, and the installation UI-C for the visually impaired memory area 16a3 stores an installation UI-C for the visually impaired. The installation UI-A, installation UI-B and installation UI-CA are operation screens that facilitate input operations for visually impaired users, each of these operation screens is described later in detail with reference to FIG. 2.

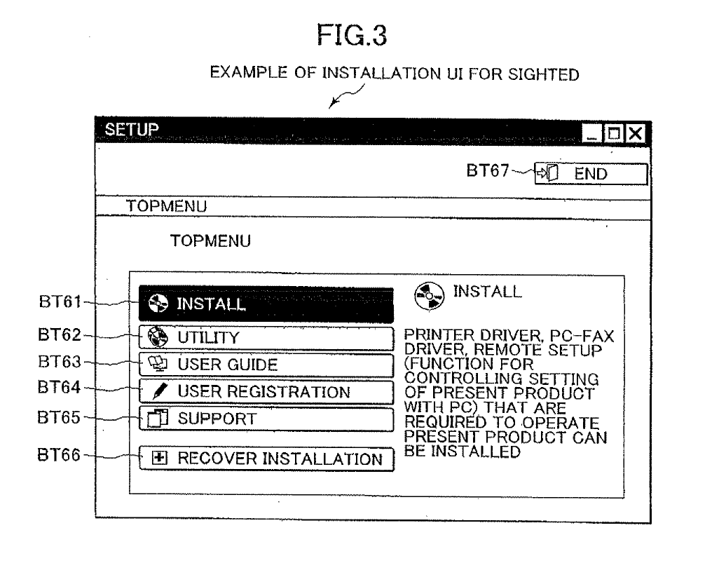

The installation UI for the sighted memory area 16a4 stores an installation UI for the sighted (described later in greater detail with reference to FIG. 3), which is an operation screen that facilitates input operations for a sighted user. The installation UIs for the visually impaired (−A, −B, and −C) and the installation UI for the sighted are operation screens of the installation program.

The application program X data memory area 16b stores data required to build the application program X. When executed, the installation program acquires the data from the application program X data memory area 16b and copies this data to the application program X memory area 14c of the hard disk 14. The installation program also modifies setting options and the like in the OS in order to execute the application program X. The series of steps performed by the installation program is referred to as a setup process. The application program X data memory area 16b also stores data referenced during the setup process, and the like.

The keyboard 17 is an input device having a plurality of keys. When the operator presses these keys, input signals corresponding to the pressed keys are inputted into the PC 1. The mouse 18 is a pointing device used to indicate display positions with a mouse cursor displayed on the LCD 19. When the operator moves the position of the mouse cursor with the mouse 18, an input signal corresponding to the amount of movement is inputted into the PC 1 and the display position of the mouse cursor is moved based on the input signal.

The mouse 18 also has a mouse button that the user can operate while moving the position of the mouse cursor. When the user operates this button, a prescribed input signal is inputted into the PC 1. By operating the keyboard 17 and the mouse 18, the user can modify various settings in the OS and the like and can execute the application program X and the like.

The LCD 19 functions to display operating procedures and the process status during the execution of operations, as well as data corresponding to keys pressed on the keyboard 17 and operations performed with the mouse 18. The speaker 20 outputs voice signals or the like provided by the screen reader as voice.

The LAN interface 21 is a circuit well known in the art for facilitating data communications with various external devices connected to the LAN 200 by connecting one end of a LAN cable to a connection port of the LAN interface 21 and the other end to the LAN 200.

Next, the installation UIs for the visually impaired (−A, −B, and −C) and the installation UI for the sighted will be described with reference to FIGS. 2 and 3.

FIG. 2(a) is a screenshot showing an example of the installation UI-A for the visually impaired stored in the installation UI-A for the visually impaired memory area 16a1 and the installation UI-B for the visually impaired stored in the installation UI-B for the visually impaired memory area 16a2. FIG. 2(b) is a screenshot showing an example of the installation UI-C for the visually impaired stored in the installation UI-C for the visually impaired memory area 16a3. FIG. 3 is a screenshot showing an example of the installation UI for the sighted stored in the installation UI for the sighted memory area 16a4.

Each of the installation UIs for the visually impaired (−A, −B, and −C) and the installation UI for the sighted is an operation screen of the installation program. When executed, the installation program displays one of these operation screens on the LCD 19.

Each of the installation UIs for the visually impaired (−A, −B, and −C) is configured of a lot of text data, while restricting the use of images. The installation UI for the sighted is configured with a lot of images.

The installation UI-A for the visually impaired is an operation screen suited to a screen reader A. The installation UI-B for the visually impaired is an operation screen suited to a screen reader B. The installation UI-C for the visually impaired is an operation screen voiced with a general screen reader.

First the installation UI-A for the visually impaired suited to the screen reader A will be described.

As shown in FIG. 2(a), an Install button BT31, a Utility button BT32, a User Guide button BT33, a User Registration button BT34, a Support button BT35, and a Recover Installation button BT36 are arranged in order from top to bottom in the center of the installation UI-A for the visually impaired. Further, an End button BT37 is provided in the upper right corner of the installation UI-A for the visually impaired.

The Install button BT31 functions to initiate setup of the application program X. The Utility button BT32 functions to perform settings for the MFP 100 and the like. The User Guide button BT33 functions to display a manual for the application program X on the LCD 19. The User Registration button BT34 functions to register the user of the application program X via the LAN 200.

The Support button BT35 functions to issue an inquiry via the LAN 200 regarding the method of using the application program X and the like. The Recover Installation button BT36 functions to repeat the setup process (reinstallation) when an error occurs with the installed application program X. The End button BT37 functions to quit the installation program.

The button name “Install (I)” has been assigned to the Install button BT31 and is displayed inside the Install button BT31. Similarly, the button name “Other Software and Utilities (O)” has been assigned to the Utility button BT32, the button name “User Guide (U)” to the User Guide button BT33, the button name “Register Online User (T)” to the User Registration button BT34, the button name “Service and Support (S)” to the Support button BT35, the button name “Recover Installation (R)” to the Recover Installation button BT36, and the button name “End (E)” to the End button BT37, each of which button names is displayed in the corresponding button BT32-BT37.

Since the button names displayed in the buttons BT31-BT37 are configured of text data, the user can select the buttons BT31-BT37 through key operations or the like. Screen reader A voices each of the button names when the buttons BT31-BT37 are selected through key operations or the like while screen reader A is running on the PC 1, thereby facilitating input operations for a visually impaired user.

In addition, embedded text data corresponding to each button name is assigned to each of the buttons BT31-BT37. More specifically, the embedded text data “Install” is assigned to the Install button BT31, “Other Software and Utilities” to the Utility button BT32, “User Guide” to the User Guide button BT33, “Register Online User” to the User Registration button BT34, “Service and Support” to the Support button BT35, “Recover Installation” to the Recover Installation button BT36, and “End” to the End button BT37. In the present embodiment, embedded text data is identical with the text data voiced by the screen reader B. However, text data different from the text data voiced by the screen reader B may be embedded.

Hence, when the user performs key operations or the like to select one of the buttons BT31-BT37 while screen reader A is running on the PC 1, screen reader A voices the embedded text data associated with the selected button name. Accordingly, screen reader A voices single words or simple phrases. This system is user-friendly for visually impaired users since such users can accurately understand the text data selected through key operations.

Thus, a visually impaired user can perform all operations in the UI with a screen reader. In other words, a visually impaired user can install the application program X without the assistance of a sighted person.

Now, with the installation UI-A for the visually impaired described above, the user can operate the buttons BT31-BT37 with the keyboard 17 and mouse 18 to implement the corresponding functions. Here, when performing input operations, the user first performs an identification operation to identify one of the buttons BT31-BT37 as an operation target, and subsequently an execution instruction to instruct for executing the operation.

The button BT31-BT37 that has been identified as the operation target, i.e., the button that has been put in the state for which an execution instruction can be inputted, is referred to as the “input focus” in the preferred embodiment. The input focus is said to have shifted when a different button BT31-BT37 is specified.

When performing the input operation with the keyboard 17, the user performs an identification operation by pressing the Tab key provided on the keyboard 17, for example. Each time the user presses the Tab key, the input focus moves one at a time through the buttons BT31-BT37 in a prescribed sequence. The user repeatedly presses the Tab key until the input focus has reached the desired button. When the desired input focus has been set, the user presses the Return key to execute the operation of the button BT31-BT37 selected as the input focus. To simplify the description, it will be assumed hereafter that an execution instruction for a button displayed on the LCD 19 denotes that this button was pressed, regardless of whether the input operation was performed with the keyboard 17 or mouse 18.

Each time the input focus is set to one of the buttons BT31-BT37, the screen reader converts the button name displayed in the button selected as the input focus or embedded text data corresponding to the button name to voice outputted from the speaker 20.

Further, when an identification operation is performed using the mouse 18, the identification operation and execution instruction are performed simultaneously. For example, by moving the display position of the mouse cursor displayed on the LCD 19 over the display position of one of the buttons BT31-BT37 and pressing the mouse button (referred to as a “mouse click”), the user can perform an identification operation and input an execution instruction for the specified button BT31-BT37.

Next, the installation UI-B for the visually impaired suited to screen reader B will be described.

As with the installation UI-A for the visually impaired, the installation UI-B for the visually impaired is an operation screen displayed on the LCD 19 and will be described with reference to FIG. 2(a). The following description will focus only on the differences from the installation UI-A for the visually impaired.

The installation UI-B for the visually impaired is provided with buttons BT41-BT47 (indicated in parentheses in FIG. 2(a)) corresponding to the buttons BT31-BT37 of the installation UT-A for the visually impaired.

The buttons BT41-BT47 are identical to the buttons BT31-BT37, excluding the embedded text data. Since the installation UI-B for the visually impaired does not include the embedded data provided in the installation UI-A for the visually impaired, the amount of data constituting this operation screen is less than that for the installation UI-A for the visually impaired.

Hence, when screen reader B, which cannot read embedded data, is executing on the PC 1, the installation program can reduce the amount of data occupying the RAM 13 by using the installation UI-B for the visually impaired.

Next, the installation UI-C for the visually impaired capable of being voiced by a general screen reader will be described.

As shown in FIG. 2(b), the installation UI-C for the visually impaired is provided with buttons BT51-BT57 corresponding to the buttons BT41-BT47 of the installation UI-B for the visually impaired. The following description will focus only on the differences from the installation UI-B for the visually impaired.

The buttons BT51-BT57 are identical to the buttons BT41-BT47 of the installation UI-B for the visually impaired, excluding the parentheses and text data included in the parentheses.

For example, whereas the button name “Install (I)” is assigned to the button BT41 in the installation UI-B for the visually impaired, the button name “Install” is assigned to the button BT51 in the installation UI-C for the visually impaired. Hence, parentheses and text data included in the parentheses, such as “(I)” in this example, are removed from the button name used in the installation UI-B for the visually impaired. Similarly, button names for the buttons BT52-BT57 are formed by removing the “O”, “U”, “T”, “S”, “R”, and “E” from the respective button names used in the installation UI-B for the visually impaired.

Since the button names for the buttons BT51-BT57 do not include parentheses and text within the parentheses, the screen reader does not voice such symbols when the operator selects the buttons BT51-BT57 through key input or the like. Accordingly, the content of voice outputted through the speaker 20 is easy to understand, even when the visually impaired operator is using a general screen reader.

Next, the installation UI for the sighted will be described.

FIG. 3 is a screenshot showing an example of an installation UI for sighted. The installation UI for the sighted is an operation screen configured of a lot of images. By selecting images with the mouse 18, a sighted user can complete input operations in fewer steps than with the keyboard 17.

As shown in FIG. 3, an Install button BT61, a Utility button BT62, a User Guide button BT63, a User Registration button BT64, a Support button BT65, and a Recover Installation button BT66 are provided from top to bottom in the center of the installation UI for the sighted. An End button BT67 is also provided in the upper right corner of the UI.

Since the buttons BT61-BT67 correspond to the buttons BT31-BT37 of the installation UI-A for the visually impaired, the functions of the buttons BT61-BT67 will not be described.

The button name “Install” has been assigned to the Install button BT61 and is displayed within the Install button BT61. Similarly, the button name “Other Software and Utilities” has been assigned to the Utility button BT62, “User Guide” to the User Guide button BT63, “Register Online User” to the User Registration button BT64, “Service and Support” to the Support button BT65, “Recover Installation” to the Recover Installation button BT66, and “End” to the End button BT67. Each of these button names is displayed with the corresponding buttons BT62-BT67.

As described above, the screen reader cannot voice button names not configured of text data. Since the button names displayed in the buttons BT61-BT67 are configured of images, a screen reader cannot voice the button names. Therefore, a visually impaired user would have difficulty performing in put operations in the installation UI for the sighted. On the other hand, the sighted can perform input operations with the mouse 18 to complete installation in fewer input operations than when using the keyboard 17.

In addition, an image illustrating the function of each button is displayed to the left of the corresponding button name. For example, an image depicting a CD-ROM drawing an association with the installation process is displayed next to the Install button BT61. Similarly, an image depicting a plurality of CD-ROMs is displayed next to the Utility button BT62, an image depicting a file is displayed next to the User Guide button BT63, an image depicting a pen is displayed next to the User Registration button BT64, an image depicting a clipboard is displayed next to the Support-button BT65, an image depicting repair work is displayed next to the Recover Installation button BT66, and an image depicting an exit door is displayed next to the End button BT67.

When the user moves the mouse cursor over one of the buttons BT61-BT67, a description for the function of the button at the last cursor position is displayed in the installation UI for the sighted. Hence, a sighted user can guess the function of each button by looking at the image displayed next to the corresponding button and can display a description of the function by moving the mouse cursor over the button, making operations in the installation UI for the sighted easier than those performed in the installation UI-A, UI-B, and UI-C for the visually impaired.

Next, the UI for the visually impaired and the UI for the sighted will be described with reference to FIG. 4.

The UI for the visually impaired and the UI for the sighted are operation screens of the application program X. One of these operation screens is displayed on the LCD 19 while the application program X is running.

FIG. 4(a) is a screenshot showing an example of the UI for the visually impaired stored in the visually impaired UI memory area 14c1, and FIG. 4(b) is a screenshot showing an example of the UI for the sighted stored in the sighted UI memory area 14c2.

First, the UI for the visually impaired will be described. The UI for the visually impaired has a large amount of text data with a restricted amount of images, enabling a visually impaired user to perform all operations in the operation screen using a screen reader.

In the upper region of the UI for the visually impaired are provided a selection box SB1, and a Settings button BT1. The selection box SB1 is a rectangular display region in which is displayed, in a text data form, MFPs 100 that can be used with the application program X. The Settings button BT1 functions to set various options for the application program X.

On the left side, the UI for the visually impaired has a Scan button BT2, a Photo Media Capture button BT3, a Copy button BT4, a PC-FAX button BT5, a Device Settings button BT6, and a Screen Toggling button BT7.

The Scan button BT2 is selected to use the scanner function on the MFP 100 the Photo Media Capture button BT3 to use the photo media capture function of the MFP 100, the Copy button BT4 to use the copier function of the MFP 100, and the PC-FAX button BT5 to use the PC-FAX function of the MFP 100.

The Device Settings button BT6 is selected to set various options in the MFP 100. The Screen Toggling button BT7 is provided to toggle the operation screen displayed on the LCD 19 to the UI for the sighted.

In the center area, the UI includes an Image button BT8, an OCR button BT9, an E-mail button BT10, and a File button BT11. The Image button BT8 is selected to display on the LCD 19 image data files and the like scanned using the scanner function. The OCR button BT9 is selected to execute an OCR function to create a text data file based on an image data file scanned with the scanner function. The E-mail button BT10 is selected to transmit e-mail. The File button BT11 is selected to display on the LCD 19 various files stored on the hard disk 14.

In the preferred embodiment, the button name “Settings” has been assigned to the Settings button ST1 and is displayed within the Settings button BT1. Similarly, the button name “Scan” has been assigned to the Scan button BT2, “Photo Media Capture” to the Photo Media Capture button BT3, “Copy” to the Copy button BT4, “PC-FAX” to the PC-FAX button BT5, “Device Settings” to the Device Settings button BT6, “Toggle Screen” to the Screen Toggling button BT7, “Image” to the Image button BT8, “OCR” to the OCR button BT9, “E-mail” to the E-mail button BT10, and “File” to the File button BT11. Each button name is displayed in the corresponding button BT2-BT11.

A screen reader can convert button names displayed in the buttons BT1-BT11 and all text data displayed in the selection box SB1 to voice signals in order to aid a visually impaired user in performing input operations.

Each time the input focus is set to one of the buttons BT1-BT11 or the selection box SB1, the screen reader converts the button name displayed in the buttons BT1-BT11 or the text data displayed in the selection box SB1 that has been set to the input focus to voice signals and outputs the voice from the speaker 20.

Next, the UI for the sighted will be described.

The UI for the sighted is an operation screen of the application program X. By performing input operations based on the UI for the sighted, the operator can use various functions of the MFP 100. The UI for the sighted is also configured of numerous images enabling the user to perform input operations on the images using the mouse 18, which requires less than steps than when using the keyboard 17. Hence, a sighted user can perform input operations more easily with the mouse 18 than with the keyboard 17.

FIG. 4(b) is a screenshot showing an example of the UI for the sighted. In the top region of the UI for the sighted are provided a selection box SB21 and a Settings button BT21. On the left side, the UI for the sighted is provided with a Scan button BT22, a Photo Media Capture button BT23, a Copy button BT24, a PC-FAX button BT25, and a Device Settings button BT26. On the right side, the UI for the sighted is provided with an Image graphical button GBT21, an OCR graphical button GBT22, an E-mail graphical button GBT23, and a File graphical button GBT24.

Since the buttons BT21-BT26 and the selection box SB21 correspond to the buttons BT1-BT6 and the selection box SB1 in the UI for the visually impaired respectively, a description of their functions will not be repeated. Similarly, since the graphical buttons GBT21-GBT24 correspond to the buttons BT8-BT11 in the UI for the visually impaired respectively, a description of their functions will not be repeated.

The same button names described for the buttons BT1-BT6 in the UI for the visually impaired are assigned to the buttons BT21-BT26 respectively and displayed therein. Similarly, the same button names used for the buttons BT8-BT11 are assigned to the graphical buttons GBT21-GBT24 respectively. The button names used for the buttons BT21-BT26 and the selection box SB21 and are configured of text data. However, the button names for the graphical buttons GBT21-GBT24 are configured of images.

As described above, the screen reader cannot voice button names configured of anything but text data. Hence, this UI for the sighted is configured such that a screen reader can voice button names displayed in the buttons BT21-BT26 and text data displayed in the selection box SB21, but not the button names for the graphical buttons GBT21-GBT24 since these button names are configured of images.

Since the presence of the graphical buttons GBT21-GBT24 is not announced to a visually impaired user, such users would have difficulty recognizing the graphical buttons GBT21-GBT24 or performing input operations on the same.

Further, the graphical buttons GBT21-GBT24 are configured to receive only input operations performed with the mouse 18. In other words, an identification operation and an execution instruction can only be inputted for the graphical buttons GBT21-GBT24 by moving the display position of the mouse cursor on the LCD 19 over the display position of the desired graphical buttons GBT21-GBT24 and performing a mouse click.

In addition, images suggesting the functions of the buttons BT22-BT26 are displayed to the left of the corresponding button names. For example, an image depicting a scanner to suggest the scanner function is displayed on the left side of the Scan button BT22. Similarly, an image depicting a digital camera is displayed in the Photo Media Capture button BT23, an image depicting a copier in the Copy button BT24, an image depicting a fax machine in the PC-FAX button BT25, and an image depicting an MFP in the Device Settings button BT26.

Further, when the user moves the mouse cursor over each of the buttons BT22-BT26, a description for the function of the button aligned with the mouse cursor is displayed in the UI for the sighted. Accordingly, a sighted user can guess the function of the buttons BT22-BT26 by viewing the images displayed therein and can display a description of the buttons by moving the mouse cursor over the desired button. Hence, operations performed in the UI for the sighted are more user-friendly than in the UI for the visually impaired.

Next, a main process executed by the CPU 11 of the PC 1 will be described with reference to FIG. 5. FIG. 5 is a flowchart illustrating steps in the main process.

The main process is performed to execute a setup process for the application program X and to set the operation screen for the application program X to display on the LCD 19 based on whether a screen reader is installed on the PC 1. The CPU 11 executes this main process when the installation program is launched.

In S11 of the main process, the CPU 11 initializes the RAM 13. In S12 the CPU 11 determines whether a screen reader is installed in the hard disk 14. For example, in S12, the CPU 11 determines that a screen reader is installed on the hard disk 14 when settings data for an existing screen reader is recorded in the registry. The registry functions to store settings data for the OS and various programs. As a variation of the process in S12, the CPU 11 may determine that a screen reader is installed on the hard disk 14 when files and folders related to an existing screen reader exist in the hard disk 14.

If a screen reader is installed (S12: YES), in S13 the CPU 11 executes a voicing screen displaying process. The voicing screen displaying process of S13 described later is executed to instruct the application program X to display one of the installation UIs for the visually impaired (−A, −B, and −C) on the LCD 19 suited to the type of screen reader installed on the hard disk 14.

After either one of the installation UI for the visually impaired (−A, −B, and −C) is displayed on the LCD 19 in S13, in S14 the CPU 11 displays a dialog box A (see FIG. 6(a)) on the LCD 19 prompting the user to confirm whether to switch the installation UI for the visually impaired displayed on the LCD 19 to the installation UI for the sighted.

A dialog box is a window displaying a message requesting the user to input an instruction regarding the process to execute next or a message requesting confirmation, and is capable of receiving user input.

Here, the dialog box A will be described with reference to FIG. 6(a).

FIG. 6(a) is a screenshot showing an example of the dialog box A. The dialog box A is a window displaying a message prompting the user to confirm whether to switch the installation UI for the visually impaired displayed on the LCD 19 to the installation UI for the sighted and receives an instruction inputted by the user.

The dialog box A is provided with a text box TB71 in which a message is displayed prompting the user to confirm whether to switch the installation UI for the visually impaired to the installation UI for the sighted, a button BT71 with which the user can input an instruction to toggle the installation UI for the visually impaired to the installation UI for the sighted, and a button BT72 with which the user can input an instruction not to toggle the installation UI.

For example, the text box TB71 includes the text data “The screen type can be switched to a visual screen suitable for mouse operations (note: the visual screen cannot be read by voicing software nor operated with the keyboard).

Further, a button name “Yes” is assigned to the button BT71 and a button name “No” is assigned to the button BT72. These button names are displayed in their respective buttons.

The text data displayed in the text box TB71 provided in the dialog box A and the button names displayed in the buttons BT71 and BT72 are configured of images that cannot be voiced with a screen reader. In other words, a visually impaired user is unlikely to recognize the dialog box A since the text data and other content displayed therein is not voiced for the user. Therefore, it is unlikely that a visually impaired user will switch the installation UI for the visually impaired to the installation UI for the sighted by performing an input operation on the button BT71 in dialog box A. Consequently, when a visually impaired user is operating the PC 1, the installation UI for the visually impaired will remain displayed on the LCD 19.

Further, dialog box A is configured to receive input operations only through the mouse 18, and the installation UI for the visually impaired displayed on the LCD 19 is switched to the installation UI for the sighted only when the button BT71 is pressed with the mouse 18. Since it is difficult for a visually impaired user to perform input operations using the mouse 18, it is unlikely that such a user will select the button BT71 to switch the installation UI for the visually impaired to the installation UI for the sighted. Accordingly, when a visually impaired user is operating the PC 1, the installation UI for the visually impaired will remain displayed on the LCD 19. Further, the operation screen will not be changed when the button BT72 is pressed. Dialog box A closes when one of the buttons BT71 and BT72 is pressed.

Returning to the flowchart in FIG. 5, after completing the process in S14, in S15 the CPU 11 determines whether the user performed an operation to select the Yes button BT71 in dialog box A displayed on the LCD 19. If the No button BT72 was pressed (S15: NO), the installation UI for the visually impaired is left on the LCD 19. As a variation of the process in S15, the CPU 11 may determine that the No button BT72 was pressed if an input operation is not performed on the buttons BT71 and BT72 within a prescribed time (one minute, for example) after dialog box A was displayed on the LCD 19 in S14.

In S16 the CPU 11 determines one of the Install buttons BT31, BT41, and BT51 is pressed in the installation UI for the visually impaired. If one of the Install buttons BT31, BT41, and BT51 is not pressed (S16: NO), the CPU 11 waits until one of the Install buttons BT31, BT41, and BT51 is pressed.

If one of the install buttons BT31, BT41, and BT51 is pressed in the installation UI for the visually impaired (S16: YES), in S17 the CPU 11 performs a setup process for the application program X. In the setup process, the CPU 11 reads data required for building the application program X from the application program X data memory area 16b and copies the data to the application program X memory area 14c. The CPU 11 also modifies settings data for the OS in order that the application program X can be executed.

After completing the setup process, in S18 the CPU 11 stores, in the UI type memory area 14c3 of the hard disk 14, a UI type indicating that the operation screen to be displayed on the LCD 19 is the UI for the visually impaired (“1”, for example), and subsequently ends the main process. If the application program X is launched when the UI type indicating that the operation screen to be displayed on the LCD 19 is the UI for the visually impaired is stored in the UI type memory area 14c3, the application program X displays the UI for the visually impaired on the LCD 19.

However, if the CPU 11 determines in S12 that a screen reader is not installed in the hard disk 14 (S12: NO), or if the CPU 11 determines in 815 that the Yes button BT71 was pressed in dialog box A displayed on the LCD 19 (S15: YES), in S19 the CPU 11 displays the installation UI for the sighted on the LCD 19. In S20 the CPU 11 determines the Install button BT61 is pressed in the installation UI for the sighted. If the Install button BT61 is not pressed (S20: NO), the CPU 11 waits until the Install button BT61 is pressed. If the Install button BT61 is pressed (S20: YES), In S21 the CPU 11 performs the setup process for the application program X.

After completing the setup process, in S22 the CPU 11 stores, in the UI type memory area 14c3 of the hard disk 14, the UI type indicating that the operation screen to 30 be displayed on the LCD 19 is the UI for the sighted (“2”, for example), and subsequently ends the main process. If the application program X is launched when the UI type indicating that the operation screen to be displayed on the LCD 19 is the UI for the sighted is stored in the UI type memory area 14c3, the application program X displays the UI for the sighted on the LCD 19.

Through the main process described in FIG. 5, the CPU 11 can perform the setup process for the application program X and can specify the operation screen for the application program X to display on the LCD 19 based on whether a screen reader is installed on the PC 1.

In other words, the UI type indicating that the operation screen to be displayed on the LCD 19 is the UI for the visually impaired is stored in the UI type memory area, 14c3 when a screen reader is installed on the PC 1, since screen readers are primarily used by visually impaired users. This method is user-friendly to visually impaired users because such users need not switch the operation screen since the UI for the visually impaired is displayed on the LCD 19 when the application program X is launch, enabling the visually impaired user to perform operations based on voice outputted by the screen reader.

However, the UI type indicating that the operation screen to be displayed on the LCD 19 is the UI for the sighted is stored in the UI type memory area 14c3 when a screen reader is not installed on the PC 1. This method is user-friendly for sighted users who do not use a screen reader since the UI for the sighted is displayed on the LCD 19 when the application program X is launched.

Further, the installation UI for the visually impaired displayed on the LCD 19 can be switched to the installation UI for the sighted under the condition that an instruction is inputted to switch the installation UI when dialog box A is displayed. Therefore, this method reduces the chance of the UI type indicating that the operation screen to be displayed on the LCD 19 is the UI for the visually impaired being stored in the UI type memory area 14c3 when the operator is sighted.

The input operation for switching the installation UI for the visually impaired to the installation UI for the sighted must be performed with the mouse 18. Since it is difficult for a visually impaired user to perform an input operation using the mouse 18, it is unlikely that such a user will switch the operation screen. Accordingly, when a visually impaired user is operating the PC 1, the installation UI for the visually impaired will remain displayed on the LCD 19.

Next, the voicing screen displaying process of S13 executed by the CPU 11 of the PC 1 will be described with reference to FIG. 6(b).

FIG. 6(b) is a flowchart illustrating steps in the voicing screen displaying process. This process is performed to display an operation screen on the LCD 19 from among the installation UIs for the visually impaired (−A, −B, and −C) suited to the type of screen reader installed in the hard disk 14.

In S31 at the beginning of the voicing screen displaying process, the CPU 11 determines whether screen reader A is installed on the hard disk 14.

The CPU 11 determines that screen reader A is installed when settings data for screen reader A is recorded in the registry, for example. As a variation of the in S31, the CPU 11 may determine that screen reader A is installed when files and folders related to screen reader A exist in the hard disk 14.

If the CPU 11 determines that screen reader A is installed on the hard disk 14 (531: YES), in S32 the CPU 11 displays the installation UI-A for the visually impaired suited to screen reader A on the LCD 19, and subsequently ends the voicing screen displaying process.

However, if the CPU 11 determines that screen reader A is not installed on the hard disk 14 (S31: NO), in S33 the CPU 11 determines whether screen reader B is installed on the hard disk 14. The CPU 11 determines whether screen reader B is installed according to the same methods described above for screen reader A.

If the CPU 11 determines that screen reader B is installed on the hard disk 14 (S33: YES), in S34 the CPU 11 displays the installation UI-B for the visually impaired suited to screen reader B on the LCD 19, and subsequently ends the voicing screen displaying process.

However, if the CPU 11 determines that screen reader B is not installed on the hard disk 14 (S33: NO), in S35 the CPU 11 displays the installation UI-C for the visually impaired, which can be voiced by a general screen reader, on the LCD 19, and subsequently ends the voicing screen displaying process.

Through the voicing screen displaying process described in FIG. 6, the CPU 11 can display an operation screen from among the installation UIs for the visually impaired (−A, −B, and −C) on the LCD 19 that is suited to the type of screen reader installed on the hard disk 14.

Since the installation UI-A for the visually impaired is properly voiced by screen reader A and the installation UI-B for the visually impaired is properly voiced by screen reader B, the visually impaired user can correctly understand the voiced content outputted from the speaker 20.

Further, if a screen reader other than screen readers A and B is installed on the PC 1, the installation UI-C for the visually impaired is displayed on the LCD 19. Since the installation UI-C for the visually impaired can be voiced by a general screen reader, the visually impaired user can understand the voiced content outputted from the speaker 20.

Displaying one of the installation UIs for the visually impaired (−A, −B, and −C) when a screen reader is installed on the PC 1 enables the visually impaired user to perform operations based on voice outputted by the screen reader. Accordingly, a visually impaired user can install the application program X without assistance from a sighted person.

As described above, the installation program according to the first embodiment stores, in the UI type memory area 14c3, the UI type indicating that the operation screen to be displayed on the LCD 19 is the UI for the visually impaired, when a screen reader is installed on the PC 1. Hence, since the UI for the visually impaired is displayed on the LCD 19 when the application program X is launched, the visually impaired user need not toggle the operation screen, making the system more user-friendly for such users and enabling the visually impaired user to perform operations according to voice outputted by the screen reader.

On the other hand, if a screen reader is not installed on the PC 1, the installation program stores, in the UI type memory area 14c3, the UI type indicating that the operation screen to be displayed on the LCD 19 is the UI for the sighted. Accordingly, the UI for the sighted is displayed on the LCD 19 when the application program X is launched, which UI is more convenient for a sighted user who does not require a screen reader.

The installation program also switches the installation UI for the visually impaired displayed on the LCD 19 to the installation UI for the sighted under the condition that an instruction to switch the installation UI was inputted while dialog box A was displayed. Therefore, the installation program reduces the chance of the UI type indicating that the operation screen displayed on the LCD 19 is the UI for the visually impaired being stored in the UI type memory area 14c3 when the user is sighted.

Further, input operations to switch the installation UI for the visually impaired to the installation UI for the sighted must be performed with the mouse 18. Since it is difficult for a visually impaired user to perform input operations using the mouse 18, it is unlikely that such a user will switch the operation screen by accident. Hence, the installation UI for the visually impaired will remain displayed on a the LCD 19 when a visually impaired user is operating the PC 1.

Next, an installation program according to a second embodiment of the present invention will be described with reference to FIG. 7.

The installation program according to the second embodiment is installed on a PC 31 and is launched to install on the PC 31 an application program X having an operation screen for the visually impaired suitable for a screen reader and an operation screen for the sighted. The installation program sets which operation screen the application program X displays based on characteristics of input operations performed on the PC 31.

Next, the electrical structure of the PC 31 according to the second embodiment will be described with reference to FIG. 7(a).

FIG. 7(a) is a block diagram showing the electrical structure or a RAM 33 provided in the PC 31. Since the PC 31 of the second embodiment differs from the PC 1 according to the first embodiment only in the RAM 33, only the RAM 33 will be described below.

The RAM 33 is a rewritable volatile memory used to temporarily store various data when the CPU 11 executes operations on the PC 31. The RAM 33 is provided with a key input count memory area 33a, and a mouse input count memory area 33b.

The key input count memory area 33a stores a count indicating the number of times the operator has performed a prescribed key operation (pressed a key, for example) on the keyboard 17. The count in the key input count memory area 33a is incremented by “1” each time the user performs a prescribed key operation on the keyboard 17, for example.

The mouse input count memory area 33b stores a count indicating the number of times the operator has performed a prescribed mouse operation (mouse click, for example) on the mouse 18. The count stored in the mouse input count memory area 33b is incremented by “1” each time the user performs a prescribed mouse operation on the mouse 18, for example.

Next, a main process executed by the CPU 11 of the PC 31 will be described with reference to FIG. 7(b).

FIG. 7(b) is a flowchart illustrating steps in the main process.

The main process according to the second embodiment replaces the process in S12 of the main process according to the first embodiment (see FIG. 5) with the process in S41-S47 shown in FIG. 7(b). Accordingly, only the new steps shown in FIG. 7(b) will be described below, while a description of steps identical to those in the first embodiment will be omitted.

The main process is performed to execute the setup process for the application program X and to set the operation screen that the application program X displays on the LCD 19 based on characteristics of input operations performed through the keyboard 17 or the mouse 18 while the installation program is running. At the beginning of the main process in S11 of FIG. 5, the CPU 11 initializes the key input count memory area 33a and mouse input count memory area 33b in the RAM 33.

Here, the operator also performs the key operation or mouse operation for other than the operation screen in order to perform the installing. The CPU 11 simply acquires the key operation or mouse operation, regardless of whether the input operation was performed in the operation screen of the installation program. In S41 of FIG. 7(b), the CPU 11 acquires a key operation performed with the keyboard 17 or a mouse operation performed with the mouse 18.

In S42 the CPU 11 determines whether the input operation acquired in S41 was any one of a Tab key, Control key and Tab key, Space key, Alt key, or Arrow keys. If the acquired input operation was one of the above keys (S42: YES), in S43 the CPU 11 increments the value stored in the key input count memory area 33a of the RAM 33 by “1”.

In S44 the CPU 11 determines whether the count stored in the key input count memory area 33a has exceeded “10”. If the count has exceeded “10” (S44: YES), then the CPU 11 advances to S13 in the flowchart of FIG. 5.

However, if the count is no greater than “10” (S44: NO), then the CPU 11 returns to S41 and repeats the process in S41-S44 described above.

Further, if the CPU 11 determines in S42 that the acquired input operation is not one of the above listed operations (S42: NO), in S45 the CPU 11 determines whether the acquired input operation was a mouse click. If the acquired input operation was a mouse click (S45: YES), in S46 the CPU 11 increments the count in the mouse input count memory area 33b of the RAM 33 by “1”. In S47 the CPU 11 determines whether the count stored in the mouse input count memory area 33b has exceeded “5”. If the count has exceeded “5” (S47: YES), then the CPU 11 advances to S18 in the flowchart of FIG. 5.

However, if the CPU 11 determines in S45 that the acquired input operation was not a mouse click (S45: NO), the CPU 11 returns to S41 and repeats the process in S41-S45 described above. Further, if the CPU 11 determines in S47 that the count is no greater than “5” (S47: NO), then the CPU 11 returns to S41 and repeats the process in S41-S47 described above.

Since a visually impaired user has difficulty performing input operations while viewing the operation screen, it can be considered less likely that a visually impaired user would perform input operations with the mouse 18 in comparison to a sighted user. Further, since the sighted user can perform input operations while viewing the operation screen, the sighted user is probably more likely to perform input operations with the mouse 18 than a visually impaired user since tasks can be completed in fewer operations on the mouse 18 than on the keyboard 17.

Therefore, it can be thought that a visually impaired user is operating the PC 31 when most input operations are performed with the keyboard 17, as determined in S44, and that a sighted user is operating the PC 31 when most input operations are performed with the mouse 18, as determined in S47.

Through the main process described in FIG. 7(b), the CPU 11 can specify the operation screen for the application program X to display on the LCD 19 based on the number of input operations performed with the keyboard 17 or the number of input operations performed with the mouse 18.

As described above, the installation program according to the second embodiment stores, in the UI type memory area 14c3, the UI type indicating that the operation screen to be displayed on the LCD 19 is the UI for the visually impaired, when the number of input operations performed on the keyboard 17 exceeds a prescribed number (10, for example). Therefore, when a visually impaired user is performing input operations, the UI for the visually impaired is displayed on the LCD 19 when the application program X is launched. This is convenient for the visually impaired user since the user need not toggle the operation screen, and allows the visually impaired user to perform operations based on voice outputted by the screen reader.

On the other hand, the installation program stores, in the UI type memory area 14c3, the UI type indicating that the operation screen to be displayed on the LCD 19 is the UI for the sighted, when the number of input operations performed on the mouse 18 exceeds a prescribed number (5, for example). Therefore, when a sighted user is performing input operations, the UI for the sighted is displayed on the LCD 19 when the application program X is launched. Accordingly, this installation program is convenient for a sighted user who does not require a screen reader.

Next, an installation program according to a third embodiment of the present invention will be described with reference to FIG. 8.

The installation program according to the third embodiment is installed on a PC 41 and is launched to install on the PC 41 an application program X having an operation screen for the visually impaired suitable for a screen reader and an operation screen for the sighted. The installation program determines whether settings on the PC 41 were established for a visually impaired user and sets which operation screen the application program X displays based on the determination results.

Next, the electrical structure of the PC 41 according to the third embodiment will be described with reference to FIG. 8(a);

FIG. 8(a) is a block diagram showing the electrical structure of a RAM 43 provided in the PC 41. Since the PC 41 of the third embodiment differs from the PC 1 according to the first embodiment only in the RAM 43, only the RAM 43 will be described below.

The RAM 43 is a rewritable volatile memory used to temporarily store various data when the CPU 11 executes operations on the PC 41. The RAM 43 is provided with a condition conformity count memory area 43a.

The condition conformity count memory area 43a stores a count indicating the number of user settings on the PC 41 performed to aid a user who is visually impaired. For example, the count stored in the condition conformity count memory area 43a is incremented by “1” for each user setting on the PC 41 designed to aid a visually impaired user, including the installation of software designed to aid a visually impaired person in using the PC, an OS setting to reduce the mouse cursor speed from the default value, and an OS setting to increase the size of the text displayed on the LCD 19 from the default value.

Next, a main process executed by the CPU 11 of the PC 41 will be described with reference to FIG. 8(b). FIG. 8(b) is a flowchart illustrating steps in this main process.

The main process according to the third embodiment replaces the process in S12 of the main process according to the first embodiment (see FIG. 5) with the process in S51-S59 shown in FIG. 8(b). Accordingly, only the new steps shown in FIG. 8(b) will be described below, while a description of steps identical to those in the first embodiment will be omitted.

This main process is performed to execute a setup process for the application program X and to specify the operation screen that the application program X displays on the LCD 19 based on the number of settings on the PC 41 established for a visually impaired user. In S11 of FIG. 5, the CPU 11 first initializes the condition conformity count memory area 43a in the RAM.

In S51 the CPU 11 determines whether the speed of mouse cursor movement in the OS settings is slower than the default setting established when the OS was installed. If the mouse cursor speed is set slower than the default setting (S51: YES), in S52 the CPU 11 increments the value stored in the condition conformity count memory area 43a by “1”. However, if the mouse cursor is not set slower than the default setting (S51: NO), the CPU 11 skips S52 and advances to S53.

In S53 the CPU 11 determines whether the text size set in the OS settings for the size of text displayed on the screen is larger than the default setting established when the OS was installed. If the text size is set larger than the default setting (S53: YES), in S54 the CPU 11 increments the value in the condition conformity count memory area 43a by “1”. However, if the text size is not set larger than the default setting (S53: NO), the CPU 11 skips S54 and advances to S55.

In S55 the CPU 11 determines whether a screen reader has been installed on the hard disk 14. If a screen reader has been installed on the hard disk 14 (S55: YES), in S56 the CPU 11 increments the value stored in the condition conformity count memory area 43a by “1”. However, if a screen reader has not been installed (S55: NO), the CPU 11 skips S56 and advances to S57.

In 557 the CPU 11 determines whether the screen reader is running. If the screen reader is running (S57: YES), in S58 the CPU 11 increments the value stored in the condition conformity count memory area 43a by “1”. However, if the screen reader is not running (S57: NO), the CPU 11 skips S58 and advances to S59.

In S59 the CPU 11 determines whether the count stored in the condition conformity count memory area 43a exceeds “2”. If the count exceeds “2” (S59: YES), the CPU 11 advances to S13 in the flowchart of FIG. 5. However, if the count is no greater than “2” (S59: NO), the CPU 11 advances to S19 in the flowchart of FIG. 5.

Through the main process described in FIG. 8(b), the CPU 11 can set the operation screen that the application program X displays on the LCD 19 based on the number of settings in the PC 41 established for a visually impaired user.

With the installation program according to the third embodiment described above, the PC 41 stores, in the UI type memory area 14c3, the UI type indicating that the operation screen to be displayed in the LCD 19 is the UI for the visually impaired, after determining that the PC 41 has been set to aid a visually impaired user when the number of settings for a visually impaired user exceeds a prescribed number (2, for example). Accordingly, the UI for the visually impaired is displayed on the LCD 19 when the application program X is launched, making the system more user-friendly to a visually impaired user since the user need not switch the operation screen. As a result, the visually impaired user can perform operations based on voice outputted by the screen reader.

However, when the number of settings designed for visually impaired users does not exceed the prescribed number, the PC 41 stores, in the UI type memory area 14c3, the UI type indicating that the operation screen to be displayed in the LCD 19 is the UI for the sighted, since settings in the PC 41 have been established for a sighted user. Accordingly, the UI for the sighted is displayed on the LCD 19 when the application program X is launched, making the system convenient for sighted users who do not use a screen reader.

While the invention has been described in detail with reference to specific embodiments thereof, it would be apparent to those skilled in the art that many modifications and variations may be made therein without departing from the spirit of the invention, the scope of which is defined by the attached claims.

For example, while an installation UI for the visually impaired (−A, −B, and −C) suited to the screen reader installed on the hard disk 14 is displayed on the LCD 19 in the preferred embodiments described above, it is also possible to display on the LCD 19 an installation UI for the visually impaired suited to a screen reader executing on the PC 1, 31, or 41. In this way, the installation program can display on the LCD 19 an installation UI for the visually impaired suited to the screen reader that the user is currently running when more than one screen reader is installed on the hard disk 14, making the system more user-friendly.

Further, while the application program X according to the preferred embodiments has three operations screens suited to screen readers (UI-A, UI-B, and UI-C for the visually impaired), the installation program may also be configured to support an application program X having only one UI for the visually impaired conforming to one of the above screen readers A and B and a general screen reader. In this case, the installation program may be configured to instruct the application program X to display the UI suited to the screen reader.

Further, in S42 of FIG. 7 described in the preferred embodiments, the CPU 11 counts the number of times specific keys are pressed, but the present invention is not limited to these keys. Any keys may be counted, provided such keys are commonly used in the installation program and the OS.

Further, in the preferred embodiments described above, the main process according to the second embodiment (see FIG. 7(b)) and the main process according to the third embodiment (see FIG. 8(b)) replace S12 in the main process according to the first embodiment (see FIG. 5) with a different process. However, the main processes in the second and third embodiments may combine both the replacement processes (S41-S47 and S51-S59) with the process in S12. Specifically, when the CPU 11 determines in S12 of FIG. 5 that a screen reader has been installed (S12: YES), the CPU 11 may advance to S41 of FIG. 7 (b) or 351 of FIG. 8(b). Further, when the value stored in the key input count memory area 33a exceeds “10” in S44 of FIG. 7(b) (S44: YES), the CPU 11 may advance to S12 of FIG. 5 or S51 of FIG. 8(b). Alternatively, when the CPU 11 determines in S59 of FIG. 8(b) that the value stored in the condition conformity count memory area 43a of the RAM 43 exceeds “2” (S59: YES), the CPU 11 may advance to S12 of FIG. 5 or S41 of FIG. 7(b).

What is claimed is:

1. A data processing device on which an OS is installed and on which a screen reader and an application can be installed, the application providing with an operation screen when installed on the data processing device, the operation screen having a first operation screen for sighted users and a second operation screen for visually impaired users, the second operation screen including voicing data, the screen reader voicing the voicing data,
the data processing device comprising:
a displaying unit displaying one of the first operation screen and the second operation screen in at least one of a text character form and an image form, the screen reader voicing the voicing data when the second operation screen is displayed on the displaying unit;
a receiving unit into which input data is inputted by a user;
a determining unit configured to determine, based on at least one of the input data and settings of the OS, which of the first operation screen and the second operation screen should be displayed on the displaying unit; and
a controlling unit configured to control the displaying unit to display the first operation screen if the determining unit determines that the first operation screen should be displayed on the displaying unit, and control the displaying unit to display the second operation screen if the determining unit determines that the second operation screen should be displayed on the displaying unit.

2. The data processing device according to claim 1, further comprising an inputting unit including at least one of a key input device and a pointing device, the key input device having a plurality of keys with which the user inputs the input data into the receiving unit, a pointing device having a moving unit with which the user moves a pointer on the operation screen and a specifying button with which the user specifies a position of the pointer on the operation screen to input the input data into the receiving unit,
wherein the determining unit determines, based on at least one of the input data inputted with at least one of the key input device and the pointing device and the settings of the OS, which of the first operation screen and the second operation screen should be displayed on the displaying unit.

3. The data processing device according to claim 1, wherein the first operation screen includes a first installing procedure indicating a procedure for the sighted users to install the application on the data processing device, and the second operation screen includes a second installing procedure indicating a procedure for the visually impaired users to install the application on the data processing device, and
wherein the controlling unit controls the displaying unit to display the second Installing procedure so that the screen reader voices the second installing procedure if the determining unit determines that the second operation screen should be displayed on the displaying unit.

4. The data processing device according to claim 3, wherein the voicing data has at least one of first voicing data and second voicing data, and the screen reader has one of a first screen reader voicing the first voicing data and a second screen reader voicing the second voicing data,
wherein the data processing device further comprises a detecting unit configured to detect which of the first screen reader and the second screen reader is installed on the data processing device,
wherein the controlling unit controls, regardless of the input data and the settings of the OS, the displaying unit to display the first installing procedure if the detecting unit detects that the first screen reader is installed on the data processing device, and controls, regardless of the input data and the settings of the OS, the displaying unit to display the second installing procedure if the detecting unit detects that the second screen reader is installed on the data processing device.

5. The data processing device according to claim 1, wherein the determining unit determines, based on at least one of the input data, the settings of the OS, and whether or not the screen reader is installed on the data processing device, which of the first operation screen and the second operation screen should be displayed on the displaying unit.

6. The data processing device according to claim 5, wherein the voicing data has at least one of first voicing data and second voicing data, and the screen reader has one of a first screen reader voicing the first voicing data and a second screen rear voicing second voicing data,
wherein the data processing device further comprises a detecting unit configured to detect which of the first screen reader and the second screen reader is installed on the data processing device,
wherein the controlling unit controls, regardless of the input data and the settings of the OS, the displaying unit to display the first operation screen if the detecting unit detects that the first screen reader is installed on the data processing device, and controls, regardless of the input data and the settings of the OS, the displaying unit to display the second operation screen if the detecting unit detects that the second screen reader is installed on the data processing device.

7. The data processing device according to claim 1, further comprising:
a second controlling unit configured to control the display unit to display a screen changing request data that can be specified by the user, when the second operation screen is displayed on the displaying unit;
a specifying unit with which the user specifies the screen changing request; and
a second detecting unit configured to detect that the display request data is specified,
wherein the controlling unit controls the displaying unit to display the first operation screen if the second detecting unit detects that the screen changing request is specified.

8. The data processing device according to claim 7, wherein the screen reader fails to voice the screen changing request.

9. A computer-readable storage medium storing a set of program instructions executable on a data processing device on which an OS is installed and on which a screen reader and an application can be installed, the application providing with an operation screen when installed on the data processing device, the operation screen having a first operation screen for sighted users and a second operation screen for visually impaired users, the second operation screen including voicing data the screen reader voicing the voicing data, the data processing device including: a displaying unit displaying one of the first operation screen and the second operation screen in at least one of a text character form and an image form, the screen reader voicing the voicing data when the second operation screen is displayed on the displaying unit; and a receiving unit into which input data is inputted by a user, the program comprising instructions for:
a) determining, based on at least one of the input data and settings of the OS, which of the first operation screen and the second operation screen should be displayed on the displaying unit; and
b) controlling the displaying unit to display the first operation screen if in a) it is determined that the first operation screen should be displayed on the displaying unit, and controlling the displaying unit to display the second operation screen if in a) it is determined that the second operation screen should be displayed on the displaying unit.

10. The computer-readable storage medium according to claim 9, wherein the data processing device further includes an inputting unit including at least one of a key input device and a pointing device, the key input device having a plurality of keys with which the user inputs the input data into the receiving unit, a pointing device having a moving unit with which the user moves a pointer on the operation screen and a specifying button with which the user specifies a position of the pointer on the operation screen to input the input data into the receiving unit,
wherein a) determining, based on at least one of the input data inputted with at least one of the key input device and the pointing device and the settings of the OS, which of the first operation screen and the second operation screen should be displayed on the displaying unit.

11. The computer-readable storage medium according to claim 9, wherein the first operation screen includes a first installing procedure indicating a procedure for the sighted users to install the application on the data processing device, and the second operation screen includes a second installing procedure indicating a procedure for the visually impaired users to install the application on the data processing device, and
wherein b) controlling the displaying unit to display the second installing procedure so that the screen reader voices the second installing procedure if in a) it is determined that the second operation screen should be displayed on the displaying unit.

12. The computer-readable storage medium according to claim 11, wherein the voicing data has at least one of first voicing data and second voicing data, and the screen reader has one of a first screen reader voicing the first voicing data and a second screen reader voicing the second voicing data,
wherein the program further comprises an instruction for c) detecting which of the first screen reader and the second screen reader is installed on the data processing device,
wherein b) controlling, regardless of the input data and the settings of the OS, the displaying unit to display the first installing procedure if in c) it is detected that the first screen reader is installed on the data processing device, and controlling, regardless of the input data and the settings of the OS, the displaying unit to display the second installing procedure if in c) it is detected that the second screen reader is installed on the data processing device.

13. The computer-readable storage medium according to claim 9, wherein a) determining, based on at least one of the input data, the settings of the OS, and whether or not the screen reader is installed on the data processing device, which of the first operation screen and the second operation screen should be displayed on the displaying unit.

14. The computer-readable storage medium according to claim 13, wherein the voicing data has at least one of first voicing data and second voicing data, and the screen reader has one of a first screen reader voicing the first voicing data and a second screen reader voicing the second voicing data,
wherein the program further comprises an instruction for c) detecting which of the first screen reader and the second screen reader is installed on the data processing device,
wherein b) controlling, regardless of the input data and the settings of the OS, the displaying unit to display the first operation screen if in c) it is detected that the first screen reader is installed on the data processing device, and controlling, regardless of the input data and the settings of the OS, the displaying unit to display the second operation screen if in c) it is detected that the second screen reader is installed on the data processing device.

15. The computer-readable storage medium according to claim 9, wherein the data processing device further includes a specifying unit with which the user specifies the screen changing request, and
wherein the program further comprises instructions for:
d) controlling the display unit to display a screen changing request data that can be specified by the user, when the second operation screen is displayed on the displaying unit; and
e) detecting that the display request data is specified,
wherein b) controlling the displaying unit to display the first operation screen if in e) it is detected that the screen changing request is specified.

16. The computer-readable storage medium according to claim 15, wherein the screen reader fails to voice the screen changing request.
